(19) United States
(12) Patent Application Publication
(10) Pub. No.: US 2007/0129973 A1
(43) Pub. Date: Jun. 7, 2007

(54) System and a method for electronic registration of flying time and cosmic radiation

(75) Inventor: Peer W Wollenberg, Vaerlose (DK)

Correspondence Address: Howard J. Klein;Klein, O'Neill & Singh, LLP, 2 Park Plaza, Suite 510, Irvine, CA, 02614, US

(73) Assignee: Global Aviation Data A/S, Roskilde (DK)

(21) Appl. No.: 10/559,505

(22) PCT Filed: Jun. 4, 2004
(86) PCT No.: PCT/DK04/00386

§ 371 Date: May 31, 2006

(30) Foreign Application Priority Data
Jun. 4, 2003 (DK) PA 2003 00829

(51) Int. Cl. G06Q 10/00

(52) U.S. Cl. 705/5

(57) ABSTRACT

A system for electronic registration of air travel logbooks, wherein data input is performed by a person in two steps. The first step includes the input of data into a terminal and the correction of any errors. The second step includes the permainent storage and processing of the data in a computer. The permanent storing prevents subsequent changing of the input data, whereby the second step is performed only with access to the computer obtained by verification of conformity between the identity of the person and a password. Access to the computer is obtained by the person for the output of data regarding the person by using the password. An authority obtains access to data in the computer regarding a specific person by using a first code, and to data regarding a specific aircraft's flights by using a second code.

The present invention relates to a system and a method for electronic registration of flying time and cosmic radiation for pilots, flight crew and passengers (in the following altogether described as “persons” or “airborne”) by use of partly central, partly transportable computers and mobile/cellular phones for the registration and the transmission of the electronic data and central computers for the processing and storage of the collected data. In this context, the term ‘a computer’ is to be construed a generic term including not only a single computer, but also a set of computers, including servers, networks and possibly also connections through the Internet to other computers and/or computer systems.

Throughout the world, it is a law requirement that pilots keep a detailed report of their flying time, a so-called pilot's logbook. Until today, such a log has been conducted manually by using paper and ink in the same way as an old-fashioned book-keeping system using an accountancy book with lines and columns specially designed for that purpose. On each line one flight is entered as a number of different data, such as the date, the type of flight, registration, place and time of departure, place and time of arrival, total flying time, time as Pilot in Command and First Officer, flying time night or day, single-engine or multi-engine aircrafts etc. All these time data are to be entered in the log according to the above mentioned law requirements immediately after a flight or at least the same day.

There are no requirements stating that the flight crew must keep any kind of log and of course, nor must passengers. It has, however, become a requirement that the employers of radiation exposed employees (in Europe so far) make annual reports of the radiation dose of the employees in connection with the execution of their profession. As for the flight crew members, the dose of ionising radiation from space and from the sun is considerable, as well as for frequent flyers (i.e. couriers or others), a fact that has caused the aviation authorities to oblige the airline companies to perform the mentioned radiation reporting for the flight crew members and to send in an annual report of the collected dose of cosmic radiation (i.e. the sum of galactic and solar radiation) for the flight crew members to the national radiation authorities. A corresponding obligation will also be imposed to other employers, where the employees, by virtue of their profession, annually collect a dose exceeding 1 milliSievert (1 mSv). This is why passengers will also be part of a possible target group. As embryos/foetus during their development are particularly vulnerable, pregnant women will also be part of the target group.

The strict law requirements and the requirement as to the security of data registration has till now prevented the authorities from wanting to accept electronic data as-sufficient documentation for the pilots total and current flying time. The background for this is that with a simple book-keeping system in a computer, it cannot to a sufficient degree be ensured in any way that modifications in the registered data can be made later on as it would immediately be the case when using for instance a PC with a spreadsheet corresponding to the above mentioned column book.

Within the relevant technical field, a technique is known where data logging is automatically performed from an aircraft and this technique, which solely relates to the logging of technical data from the computer of the aircraft, is disclosed in e.g. WO 00/55770 to which publication reference is made, and which publication is hereby included in the present specification by reference.

The technique of measuring the actual radiation exposure of the flight personnel in commercial and military aircrafts has been used in certain aircrafts in particular in the Concorde used by the companies Air France and British Airways. A technique of measuring aboard an aircraft the radiation dose is known from among others U.S. Pat. No. 5,841,142, to which US patent reference is made and which US patent is hereby incorporated in the specific specification by reference.

Certain techniques relating to electronic logbooks and computerised maintenance and repair information techniques are described in among others published international patent application, publication No. WO 02/061629 and in European patent 0 573 171 corresponding to U.S. Pat. No. 5,987,474, to which patent applications and patents reference is made and which US patent is hereby incorporated in the present specification by reference.

It is an object of the present invention to provide a new technique which, by using modern computer technology, enables the substitution of the manually kept pilot's logbook, ensuring that the data logging is not subsequently modified, either intentionally or unintentionally without evidence of the correctness. However, this technique does not exclude subsequent processing of the data. At the same time, it is thus an object of the invention to provide a new technique for the registration of data input—manually or automatically—by a pilot, a flight crew member, a passenger or a substitute for one of these (e.g. the airline company in question) for a given flight with a given crew, which data input makes it possible for the authorities, among others airlines as well as aviation authorities, to control connected data and maybe to perform searches with a view to identify critical conditions, including for instance specific individuals' acting as students, instructors or pilots at given moments or in given connections and also to identify individuals reaching a limit value for cosmic radiation. In this connection it is a specific object of the invention to provide a new technique for the registration of data representing the radiation, i.e. radiation from space or the sun, which a person, whether pilot, flight crew member in general or a passenger, including a frequent flyer, which data reflect the dose that the person in question has been exposed to during a given flight and further permits an accumulation of such data for the calculation on a periodic basis, e.g. one year, of the dose which the person in question altogether has been exposed to.

It is a particular feature of the present invention to render it possible to establish a forecast of the cosmic radiation dose to which a person is to be exposed during a flight.

The above stated objects together with numerous other objects, advantages and specific features of the invention are obtained in accordance with a first aspect of the invention by a system for electronic registration of logbooks for a number of persons, including: pilots, crew members and/or passengers, which system comprises a central computer for the registration and the processing of the electronic data representing the individual person's logbook and one or more terminals for the input of the electronic data in question,

wherein the data input into the central computer regarding a specific flight performed by a person comprises:

information on the identity of the person,
information on the flight number,
information on the time of departure and arrival and consequently the flying time as well as the places of departure and arrival of the flight,
information on the status of the specific persons during the flight, i.e. Pilot in Command, First Officer, flight engineer, instructor,
student, flight crew member or passenger,
   wherein the input of the data is performed by the person in question in a process comprising two steps, the first step comprising the input of the data into the terminal and control of the data in question, including correction of any erroneously input data, if any, and the second step comprising a permanent storing and data processing of the data in question in the computer, the permanent storing preventing a subsequent correction of any of the input data without leaving a trace,
   wherein the input of data in the computer in the second step is performed in a process where the access to the computer is only obtained by positive verification of conformity between the identity of the person and a personal code word or password,
   wherein the person obtains access to the central computer for the output of data regarding the person in question by using said personal code word or password, i.e. for the reading of the person's personal logbook, and
   wherein an authority, i.e. an airline or an aviation authority obtains access to data contained in the computer regarding a specific person by using a specific first code, and obtains access to the data in the computer regarding a specific aircraft's flights by using a second code.

In accordance with the realisation being the basis of the invention, the registration of the electronic data itself in the central computer is performed by the person in question or his/her substitute in a process comprising two steps, where the writing of the data is firstly performed by which writing it is possible to make corrections and additions, after what the actual input of data in the central computer generates a calculation of the night flying time and the radiation dose and a permanent storing which cannot subsequently be changed or modified. Further in accordance with the teachings of the invention it is important that the input itself for the permanent storing in the central computer can only be performed in the name of a specific person, e.g. a flight crew member, when the input of data takes place simultaneously with an entering of the personal code word or password of the person in question and after verification of the conformity between the identity and the personal code word or password of the crew member. This securing of input of data by using a code word or a password is similarly used in accordance with the teachings of the invention when the data is read from the central computer, ensuring at the same time as regards the saved data, that it is only the data related personally to the person in question that can subsequently be at the disposal to the person in question after the entering of the personal code word or password of the crew member in question.

As regards the authorities' necessary control of the input data, this is also possible by means of a code which makes the control of interrelated data possible, i.e. the control of data for a given flight in relation to the flight crew members having manned the flight, and the time data that the pilots in question have entered for that specific flight. In relation to the existing current wish from the authorities of controlling the course of the flights, the manning and the individuals being present such as students, instructors etc., the technique according to the present invention enables the authorities, by means of a specific code, to obtain access to read data for a given person or more specifically, a given crew member.

In accordance with another aspect of the present invention it is provided, for the compliance of the above identified objects together with numerous other objects, advantages and features which will be evident from the description below, by a system for the electronic registration of cosmic radiation of a person performing a flight, which system comprises a central computer for the registration and processing of the electronic data representing the individual person's logbook and one or more terminals for the input of the electronic data in question,

wherein the data input in the central computer for a flight performed by the person in question comprises:

information on the identity of the specific person,
information on the date of the flight,
information on the flight number,
information on the time of departure and arrival and thus the flying time,
as well as the places of departure and arrival,
   wherein the input of the above mentioned data is performed by the person in question(or the person's substitute) in a process comprising two steps, where the first step comprises the actual input of the data in the terminal and control of the concerned data, including a possible correction of erroneously input data, and
   where the second step comprises a calculation of the radiation dose and a permanent storing of the concerned data in the computer where the permanent storing prevents any subsequent correction of the individually input data without leaving a trace,
   wherein the input of the data in the computer during the above mentioned second step is performed in a process, in which the access to the computer can only be obtained by positive verification of conformity between the person's identity and a personal code word or password, and
   wherein the individual person obtains access to the central computer for the reading of data for the person in question by using his personal code word or pass word.

In accordance with this second aspect of the invention, a registration of relevant data is performed with an electronic log in accordance with the same principles as described above in relation to the first aspect of the invention in order to permit a calculation of the radiation dose that a person, i.e. a pilot, a flight crew member or a passenger, including e.g. a frequent flyer, is exposed to during a given flight and an accumulated assessment of the radiation dose, which the person in question has been exposed to within a predetermined period of time, i.e. the current calendar year or the passed last twelve months. In accordance with this second aspect of the present Invention the system can be combined with the system according to the first aspect of the invention and thus in combination provide an electronic pilot logbook and a radiation dose registration unit, preferably based on the calculation programmes which are described in annex 1 and annex 2.

In the actual calculation of the accumulated dose to which a person is exposed during a flight, the data available from any observatories, such as the Apatity observatory on the Kola peninsula in Russia, and may particularly be processed in the CARI-6 programme described below in the Annex 1 and Annex 2 or alternatively, dosimetric data from more than one observatory or more than one server may be used in combination in order to Improve the accuracy of the calculation programme. The dosimetric data may further be used for providing a forecast by averaging the dosimetric data for a previous period of time and by calculating on a simulation flight from one location to another in accordance with a previous flight, or in accordance with an average of a plurality of previous flights, the accumulated dose which a person may expect to be subjected to in a future flight from the one location in question to the other location in question.

A particular aspect of the present invention relates to the actual calculation of the accumulated dose to which a person is exposed during a light and this aspect being constituting a separate and independent aspect involves the following calculations:
1. a great circle arc is created between the airport of departure and the airport of arrival
2. the arc is divided in a number of pieces which correspond to the same number of minutes of the flight
3. the position and altitude are calculated according to each point of the great circle arc
4. the radiation per hour is calculated in the reference point with the neutron counting number of the time by means of the function with the constants as Indicated in Table 4, where the relevant constants are selected from the calculated altitude of the aircraft (cf. the profile of the aircraft) at the time in question
5. the radiation power is corrected to the calculated position by getting the quotient for the actual position/altitude from the position database, and multiplying the radiation power of the reference point with the quotient.
6. the radiation dose is calculated as 1/60 of the result from point 5.
7. the time of sunrise and sunset in the point in question is calculated, and it is subsequently decided whether the latest minute of flying is to be characterised as “Flying time day” or “Flying time night”.
8. when this is done for each of the many points of the route, the partial doses are summed up to the whole of the dose of the flight
9. the dose of the flight is distributed to each of the crew members which are indicated on the crew list. Details about the flight are furthermore indicated to the pilots, which is required by the rules for the keeping of flying time. For the rest of the crew members, including so-called passive transfers (crew members to/from active service from/to their base), flight information, which is necessary for identifying the flight in question later on, is indicated.
10. For pilots, the flying time, when on service, is summed up including accumulated “Flying time day” and accumulated “Flying time night”. For a pilot who has been on board as a passenger (passive transfer), only the radiation columns are summed up. For all others (flight crew members and passengers), all the columns are summed up.

The actual calculation of the radiation dose is preferably performed by using a network defining a number of points in relation to the longitude, latitude and the altitude and possibly in combination with a GPS unit, which continuously or periodically performs a measuring of the position of the person in question or of the aircraft in which the person is situated in relation to longitude, latitude and the altitude. Alternatively, the distinct navigation system of the aircraft itself can be connected to the system according to the present invention for the transmission of data representing the aircraft and thus the exact position of the person. Similarly, other data systems in force, including the operating systems of the airline companies, can be connected to the electronic logbook or the system according to the present invention for the transmission of relevant data to both the electronic logbook as well as the radiation dose calculation system according to the second aspect of the present invention.

In accordance with a third aspect of the present invention, a method for the electronic registration of logbooks for persons, including: pilots, crew members and/or passengers by using a computer system comprising a central computer for the registration and the calculation of the electronic data representing the individual person's logbook and one or more terminals for the input of the concerned electronic data, which method comprises the input of data into the central computer for a flight performed by a person comprising:
information on the identity of the person,
information on the date of the flight,
information on the flight number,
information on the time of departure and arrival and consequently on the duration of the flight and information on the places of departure and arrival,
information on the type of flight (e.g. scheduled flight, training, military etc.)
information on the status of the person during the flight, i.e. Pilot in Command, First Officer, flight engineer, instructor, student, flight crew member or passenger,
   wherein the input of the data is performed by the person in question is carried out in a process comprising two steps, the first step comprising the input of the data into the terminal and control of the data in question, including any correction of erroneously input data, and the second step comprising the calculation of night flying time and the radiation dose as well as a permanent storing of the data in question in the computer, the permanent storing preventing a possible subsequent correction of the input data without leaving a trace,
   wherein the input of the data in the computer during the above mentioned second step is performed in a process, in which the access to the computer is only obtained by positive verification of conformity between the identity of the person and a personal code word or password,
   wherein the person obtains access to the central computer for the reading of data about the person in question, i.e. output of the personal pilot logbook of the person in question, by using his personal code word or password, and
   wherein an aviation authority, i.e. an airline company or an aviation authority obtains access to data contained in the computer regarding a specific person by using a specific first code, and obtains access to the data in the computer regarding a specific aircraft's flights by using a second code.

In accordance with a fourth aspect of the present invention, a method for the electronic registration of cosmic radiation for a person performing a flight is provided to comply with the above mentioned objects together with numerous other objects, advantages and features which will appear from the description below, by using a computer system comprising a central computer for the calculation and registration of the electronic data representing each specific person's logbook and one or more terminals for the input of the concerned electronic data, which method comprises the input of data to the central computer for a flight performed by a person, comprising:
information on the identity of the specific person,
information on the date of the flight,
information on the flight number,
information on the time of departure and arrival and thus the duration of the flight, as well as the places of departure and arrival,
   wherein the input of the above mentioned data is performed by the specific person (or the person's substitute) in a process comprising two steps, where the first step comprises the actual input of the data in the terminal and control of the concerned data, including any correction of erroneously input data, and where the second step comprises the calculation of the radiation dose and also a permanent storing of the concerned data in the computer, where the permanent storing prevents any subsequent correction of the concerned input data without leaving a trace,
   wherein the input of data in the computer during the above mentioned second step is carried out in one process, where the access to the computer can only be obtained by positive verification of conformity between the person's identity and a personal code word or password,
   wherein the specific person obtains access to the central computer for the output of data for the mentioned person by using his/her personal code word or password. In accordance with the teachings at the basis of the invention, the computer system can be implemented either as a PC or other terminal based system, where the individual PC when entering data from a data carrying medium, such as a CD, a DVD, a disk or from the Internet, is upgraded with a control programme to perform the input procedure, i.e. the input of the data into the central computer by using the code word or password verifying the authenticity of the crew member. Alternatively, the computer system can be configurated as a PC or a similar net-connected electronic data registration unit, such as a personal organiser, a WAP telephone, which via a mobile interface is used for the input of the data into the central computer via the Internet connection.

The actual control programme input of data can, as already mentioned, be performed either via a data carrying medium or by downloading the control programme from the Internet, this downloading naturally presupposing verification of the crew member's authenticity by using a personal code word or a password. Regarding the security aspects of the present invention, the following is to be noticed in particular.

1. The entering of the flying time is performed in the same way as in business accounts: the entries are made in a cash draft which is recorded after correcting errors, if any, i.e. they are transferred to the logbook itself, from which erasures and corrections cannot be made without leaving traces-see below.

2. The flying time data are stored on the Internet and cannot be erased. However, the entries can be deactivated in order not to be part of the continuous summing up of flying time, and furthermore they appear from the printout of the logbook on a light grey background.

3. All the entries are provided with two dates: the date of the flight and the date of the entry of the flight into the logbook or the date of a correction/deactivation, if any. 4. The crew member receives a password which is a condition for being able to register the flights and to print out data. This password is generated on the basis of the crew member's personal basic data, by which it will be excluded that a printout from a logbook can take place with a name which is not connected with the logbook in question.

5. The authorities receive a password that gives access to reading, and only reading, the logbooks belonging to the crew members certified in the country in question or on active service on a flight registered in the country in question.

6. In certain cases, as in the event of terrorism or a suspicion of terrorism, a password can be assigned to a single authority, giving access to the data of all crew members, irrespective of their nationality.

7. The pilot can indicate in his basic data whether he wishes to place his data at the disposal for a job database. The airline companies are (against payment if convenient) offered a password, which gives them access to search the job database for pilots, which have to meet certain requirements, among others regarding flying time, aircraft types, age, language etc., whereupon the system can send an invitation to all those who meet the requirements to apply for the position available. The individual airline company will not have any knowledge concerning names or addresses or other identification of the recipients, which leaves the individual log keeper with his/her anonymity.

8. All printouts, e.g. LogBook Printout and Recent Flight Experience Printout are provided with a Code of Authenticity. This code is generated on the basis of the date of birth of the pilot, the date of the printout and the number of flight hours. A programme is placed at the disposal to the authorities, which programme permits the decryption or the decoding of the mentioned code with the purpose of unambiguously identifying the concerned printout as being correctly printed out in accordance with the technology according to the present invention.

The use of a personal code word or password serves the primary purpose, as already mentioned, of ensuring the aviation authorities that no manipulations concerning the name or the data in the given pilot's logbook can take place. Hereby, the following advantages are obtained:

1. Manipulation with data is not possible.

2. Corrections in the logbook can not be made.

3. Erased flights clearly appear, but do of course not enter into the counting.

4. Name, personal number and serial number of the programme appear from all of the printouts, which are thereby only valid for the specific crew member who owns the logbook.

5. The printout RECENT FLIGHT EXPERIENCE can not be imitated by the crew member without the crew member making the comparison being aware of clearly committing a crime. As the printout has to be signed by the owner of the logbook in order to be valid, it is at the same time a crime carrying the signature of the criminal.

6. When using an “old-fashioned” logbook you normally only bring the latest one, even though you are in possession of several logbooks, whereas in the present case, documentation for the whole of the pilot's flying career is automatically brought along, which can be read from any computer with a connection to the Internet by using the correct code word or password. This means that the aviation authorities can easily perform the searches which may be necessary for a standard spot check control or for a more specific control of the flights in case of accidents or if there is a suspicion of manipulation with flight times.

7. In case of e.g. theft or an accident resulting in fire, or other conditions where the logbook is lost, it is easy to reproduce a new printout of the logbook.

In accordance with, the technology according to the present invention it is furthermore preferred that the data input into the central computer further comprise information about a flight in a fog or other weather with low visibility (IFR) and whether the flight can be characterised as “Cross-Country”, and any information or remarks relating to technical matters or other matters during the flight, while the part of the flight being carried out while the centre of the sun at sea level was 6 degrees or more under the horizon (night flying time), is calculated by the programme. - The dose of cosmic radiation which is inflicted on the crew and the passengers of the aircraft is also calculated by the programme. This dose is added to doses accumulated during previous flights, which then results in the accumulated dose during a lifetime so far, the dose of the current calendar year, the dose of the latest current 12 months, and also the accumulated dose since the crew member in question declared herself pregnant. It is further preferred in accordance with an advantageous embodiment of the system according to the present invention that the electronic data input into the central computer further comprise data about the individual aircraft, i.e. aircraft type, aircraft registration etc. and that the mentioned data concerning the individual aircraft, when entering the mentioned second code, is made available for an airline or an aviation authority to read. It is to be noticed that the data input in the central computer in accordance with the teachings of the present invention generally may comprise:
1. Date of the flight
2. Date of the entry/correction
3. Aircraft type
4. Aircraft registration
5. The crew members, including the owner of the logbook
6. Departure/arrival time
7. Type of flight
8. Route (place of departure, place of arrival)
9. Flying time (Blocktime)
10. The accumulated blocktime.
11. The flying time which was performed as instrument flying
12. The accumulated instrument flying time
13. The part of the flight during which the owner of the logbook was P-I-C (Pilot in Command)
14. The accumulated P-I-C time
15. The part of the flight which took place in daylight
16. The accumulated daylight flying time
17. The part of the flight which took place at night
18. The accumulated night time
19. The part of the flight which took place in good weather conditions (VFR)
20. The accumulated VFR time
21. The part of the flight which took place in single engine aircrafts
22. The accumulated single engine flying time
23. The part of the flight which took place in multi engine aircrafts
24. The accumulated multi engine flying time
25. The part of the flight which took place together with an instructor
26. The accumulated time with instructor
27. The part of the flight which took place in a sailplane
28. The accumulated sailplane time
29. The part of the flight which took place in a balloon
30. The accumulated balloon flying time
31. The part of the flight which took place in an airship
32. The accumulated airship flying time
33. The part of the flight which took place in a simulator
34. The accumulated simulator flying time
35. The part of the flight which took place in a link trainer
36. The accumulated link flying time
37. The part of the flight during which the holder of the logbook was a student
38. The accumulated student flying time
39. Number of landings during day time
40. The accumulated number of day landings
41. Number of landings during night time
42. The accumulated number of night landings
43. The part of the flight during which the holder of the logbook was an instructor
44. The accumulated number of instructor flight hours
45. The calculated dose of cosmic radiation of the flight in question indicated in mikroSievert (μSv)
46. The calculated lifetime dose of cosmic radiation - indicated in milliSievert (mSv)
47. The calculated dose of cosmic radiation of the current calendar year - indicated in milliSievert (mSv)
48. The calculated dose of cosmic radiation of the latest 12 months-indicated in milliSievert (mSv)
49. The calculated dose of cosmic radiation since the delcaration of pregnancy - indicated in milliSievert (mSv)

The detailed description of the technique for the calculation of the calculated radiation doses and night flying time for each flight appears from Annex 2¹, which together with Annex 1 serves as technical description in the present patent application.
¹ Annex 2: GLOBALOG® The Electronic Air Crew LogBook® Teknisk redegørelse for udvikling af formler og teknik til beregning af kosmiske str\dot{a}ledoser og naiflyvetid

When printing out data from the central computer it is of course important to make sure that the printout is correct and not generated from any other source, e.g. a non-authorised PC belonging to the crew member or to another institution. This verification of authenticity thus serves the purpose of proving that the specific printout of the logbook stems from and is correctly generated of the central computer and thus contains the data registered in the central computer by the specific crew member. It is thus preferred that the central computer, when reading the specific crew member's logbbok adds an authenticity code to the printout which is generated on the basis of data concerning the specific crew member, among others the date of birth of the crew member and the total flying time and also, if any, the date and time of the printout, as this code of authenticity when using a code decryption programme can be decrypted by the aviation authorities in order to be able to prove the authenticity of the printout.

The more detailed description of the use of the system itself and the implementation of the method according to the invention appears from the manual for the GlobaLog® data programme developed by the inventor, which manual is enclosed as Annex 1². Thus, this manual serves the purpose as technical description in the present patent application.
² Annex 1: GLOBALOG® THE ELECTRONIC AIR CREW LOGBOOK® User's Manual. V,1,53/2

1. System for electronic registration of logbooks for a number of persons in connection with air travel, which system comprises a central computer for the registration and the processing of electronic data representing an individual person's logbook and one or more terminals for the input of the electronic data in question, wherein the data input into the central computer regarding a specific flight performed by a person comprises:
information on the identity of the person,
information on the flight number,
information on the time of departure and arrival and consequently the flying time as well as the places of departure and arrival of the flight, information on the status of specific persons during the flight,
wherein the input of the data is performed by the person in question in a process comprising two steps, the first step comprising the input of the data into the terminal and control of the data in question, including correction of any erroneously input data, if any, and the second step comprising a permanent storing and data processing of the data in question in the computer, the permanent storing preventing a subsequent correction of any of the input data,
wherein the input of data in the computer in the second step is performed in a process where access to the computer is only obtained by positive verification of conformity between the identity of the person and a personal code word or password,
wherein the person obtains access to the central computer for the output of data regarding the person in question by using said personal code word or password, for the reading of the person's personal logbook, and
wherein an authority, obtains access to data contained in the computer regarding a specific person by using a specific first code, and obtains access to the data in the computer regarding a specific aircraft's flights by using a second code.

2. System for the electronic registration of cosmic radiation dose for a person performing a flight, which system comprises a central computer for the registration and the processing of electronic data representing the person's logbook and one or more terminals for the input of the electronic data in question,
wherein the data input into the central computer for a flight performed by the person in question comprises:
information on the identity of the specific person,
information on the date of the flight,
information on the flight number,
information on the time of departure and arrival and consequently the duration of the flight, as well as the places of departure and arrival,
wherein the input of the data is performed by the person in question in a process comprising two steps, the first step comprising the input of the data into the terminal and control of the data in question, including any correction of erroneously input data if necessary, and the second step comprising the calculation of the radiation dose and a permanent storing of the data in question in the computer, the permanent storing preventing a possible subsequent correction of any of the input data,
wherein the input of the data into the computer in the second step is performed in a process where the access to the computer is only obtained by positive verification of conformity between the identity of the person and a personal code word or password, and
wherein the person obtains access to the central computer for the output of data regarding the person in question by using said personal code word or password.

3. System according to claim 2, wherein the calculation of the radiation dose is performed by using a three-dimensional network dividing the airspace in longitude, latitude and altitude and by using the program called CARI-developed by FAA's Civil Aerospace Medical, or an equivalent dose calculation program.

4. System according to claim 1, wherein the system further comprises a GPS unit, which, for the person or for all the persons of an aircraft, carries out a calculation of the person's or the aircraft's position, either continuously or periodically in relation to the longitude, the latitude and the altitude.

5. System according claim 1, wherein calculations are performed as follows:
1. a great circle arc is created between the airport of departure and the airport of arrival;
2. the arc is divided in a number of pieces which correspond to the same number of minutes of the flight;
3. the position and altitude are calculated according to each point of the great circle arc;
4. the radiation per hour is calculated in the reference point with a neutron counting number of the time by means of the function with a set of predetermined constants, where the relevant constants are selected from the calculated altitude of the aircraft at the time in question;
5. the radiation power is corrected to the calculated position by getting the quotient for the actual position/altitude from the position database, and multiplying the radiation power of the reference point with the quotient;
6. the radiation dose is calculated as 1/60 of the result from step 5 ;
7. the time of sunrise and sunset in the point in question is calculated, and it is subsequently decided whether the latest minute of flying is to be characterized as “Flying time day” or “Flying time night”;
8. when the above steps are done for each of the many points of the route, the partial doses are summed up to the whole of the dose of the flight;
9. the dose of the flight is distributed to each crew member listed on a crew list;
10. For pilots, the flying time, when on service, is summed up including accumulated “Flying time day” and accumulated “Flying time night”;
11. For a pilot who has been on board as a passenger (passive transfer), only the radiation columns are summed up; and
12. For all others (flight crew members and passengers), all the columns are summed up.

6. System according to claim 1, wherein the individual terminal is constituted by a computer unit selected from the group consisting of at least one of a PC with a control program for the execution of the input procedure, an electronic data registration device connected to a global computer network for the input of the data into the central computer via the global computer network.

7. System according to claim 1, wherein the data input into the central computer further comprise information regarding a possible flight in the dark, in fog or other weather with low visibility (IFR), and furthermore information on whether the flight can be characterized as “Cross-Country” and also any information or remarks of technical matters during the flight.

8. System according to claim 1, wherein the electronic data input into the central computer further comprise data regarding the specific aircraft.

9. System according to claim 8, wherein the data regarding the specific aircraft when entering said second code are made available for the reading by an airline or an aviation authority.

10. System according to claim 1, wherein the central computer when reading the person's logbook adds an authenticity code to the printout, which authenticity code is generated on the basis of data regarding the person, including the person's date of birth and the complete flying time and the date and hour of the printout, as this authenticity code when using a decryption programme is decrypted by the aviation authorities in order to prove the authenticity of the printout.

11. Method for the electronic registration of logbooks for persons by using a computer system comprising a central computer for the registration and the calculation of the electronic data representing an individual person's logbook and one or more terminals for the input of the concerned electronic data, which method comprises the input of data into the central computer for a flight performed by a person comprising:
information on the identity of the person,
information on the date of the flight,
information on the flight number,
information on the time of departure and arrival and consequently on the duration of the flight and information on the places of departure and arrival,
information on the type of flight,
information on the status of the person during the flight,
wherein the input of the data is performed by the person in question and is carried out in a process comprising two steps, the first step comprising the input of the data into the terminal and control of the data in question, including any correction of erroneously input data, and the second step comprising the calculation of night flying time and the radiation dose as well as a permanent storing of the data in question in the computer, the permanent storing preventing a possible subsequent correction of the input data,
wherein the input of the data in the computer during the above mentioned second step is performed in a process, in which the access to the computer is only obtained by positive verification of conformity between the identity of the person and a personal code word or password,
wherein the person obtains access to the central computer for the reading of data about the person in question, by using said personal code word or password, and
wherein an aviation authority obtains access to data contained in the computer regarding a specific person by using a specific first code, and obtains access to the data in the computer regarding a specific aircraft's flights by using a second code.

12. Method for the electronic registration of cosmic radiation dose for a person performing a flight by using a computer system comprising a central computer for the registration and the calculation of the electronic data representing an individual person's logbook and one or more terminals for the entry of the electronic data in question, the method comprising the input into the central computer of data for a flight performed by a person comprising:
information on the identity of the specific person,
information on the date of the flight,
information on the flight number,
information on the time of departure and arrival and consequently the duration of the flight, as well as the places of departure and arrival,
wherein the input of the data is performed by the person in question in a process comprising two steps, the first step comprising the input of data into the terminal and control of the data in question, including any correction of erroneously input data, if necessary, and the second process comprising the calculation of the radiation dose and a permanent storing of the data in question in the computer, the permanent storing preventing any subsequent correction of any of the input data,
wherein the input of the data into the computer in the second step is performed in a process, where the access to the computer is only obtained by positive verification of the conformity between the identity of the person and a personal code word or password, and
wherein the person obtains access to the central computer for the output of data regarding the person in question by using said personal code word or password.

13. (canceled)

14. System according to claim 2, wherein the system further comprises a GPS unit, which, for the person or for all the persons of an aircraft, carries out a calculation of the person's or the aircraft's position, either continuously or periodically in relation to the longitude, the latitude and the altitude.

15. System according claim 2, wherein calculations are performed as follows:
1. a great circle arc is created between the airport of departure and the airport of arrival;
2. the arc is divided in a number of pieces which correspond to the same number of minutes of the flight;
3. the position and altitude are calculated according to each point of the great circle arc;
4. the radiation per hour is calculated in the reference point with a neutron counting number of the time by means of the function with a set of predetermined constants, where the relevant constants are selected from the calculated altitude of the aircraft at the time in question;
5. the radiation power is corrected to the calculated position by getting the quotient for the actual position/altitude from the position database, and multiplying the radiation power of the reference point with the quotient;
6. the radiation dose is calculated as 1/60 of the result from step 5;
7. the time of sunrise and sunset in the point in question is calculated, and it is subsequently decided whether the latest minute of flying is to be characterized as “Flying time day” or “Flying time night”;
8. when the above steps are done for each of the many points of the route, the partial doses are summed up to the whole of the dose of the flight;
9. the dose of the flight is distributed to each crew member listed on a crew list;
10. For pilots, the flying time, when on service, is summed up including accumulated “Flying time day” and accumulated “Flying time night”;
11. For a pilot who has been on board as a passenger (passive transfer), only the radiation columns are summed up; and
12. For all others (flight crew members and passengers), all the columns are summed up.

16. System according to claim 2, wherein the individual terminal is constituted by a computer unit selected from the group consisting of at least one of a PC with a control program for the execution of the input procedure, an electronic data registration device connected to a global computer network for the input of the data into the central computer via the global computer network.

17. System according to claim 2, wherein the data input into the central computer further comprise information regarding a possible flight in the dark, in fog or other weather with low visibility (IFR), and furthermore information on whether the flight can be characterized as “Cross-Country” and also any information or remarks of technical matters during the flight.

18. System according to claim 2, wherein the electronic data input into the central computer further comprise data regarding the specific aircraft.

19. System according to claim 18, wherein the data regarding the specific aircraft when entering said second code are made available for the reading by an airline or an aviation authority.

20. System according to claim 2, wherein the central computer when reading the person's logbook adds an authenticity code to the printout, which authenticity code is generated on the basis of data regarding the person, including the person's date of birth and the complete flying time and the date and hour of the printout, as this authenticity code when using a decryption programme is decrypted by the aviation authorities in order to prove the authenticity of the printout.
